(19) United States
(12) Patent Application Publication
(10) Pub. No.: US 2012/0144413 A1
(43) Pub. Date: Jun. 7, 2012

(54) RANKING CONTENT USING USER FEEDBACK

(75) Inventors: Jianwen Wang, San Jose, CA (US); Runfang Zhou, Sunnyvale, CA (US); Xin Yu, Palo Alto, CA (US); Zhaowei Jiang, Palo Alto, CA (US); Howard Cooperstein, Santa Clara, CA (US); Andy Sze-Chai Chan, Fremont, CA (US); Pierre Aoun, Los Altos, CA (US); Aparna Thyagarajan, Fremont, CA (US)

(73) Assignee: Microsoft Corporation, Redmond, WA (US)

(21) Appl. No.: 12/962,627

(22) Filed: Dec. 7, 2010

(51) Int. Cl. H04H 60/33

(52) U.S. Cl. 725/13

(57) ABSTRACT

A technology is described for ranking content using user feedback. A method can include presenting a content entry to a plurality of users to enable viewing of the content entry. Positive and negative ratings can be captured about the content entry from the plurality of users. A relative deviation value can be calculated using the positive ratings and negative ratings for the content entry to form a raw rating score using a processor. Another operation can be scaling the raw rating score via a power function to form a controversial rating score using a processor. The content entry may then be displayed in a ranked order with other content entries based on the controversial rating score.

### BACKGROUND

The opportunity to access a wide variety of media content is available today using the internet. This media content can include news, feature articles, images, editorials, videos, forum postings, and a wide range of other material. There also is a growing population of people contributing content to internet sites, where both the amount and growth rate of user generated content (UGC) has become enormous. This contributed content can include the posting original material (e.g., blogs) or the posting of feedback and comments about original material postings.

Users would like to avoid searching through these massive amounts of data to find content that is interesting. In order to rank content, users can provide feedback about content that has been accessed or viewed. Because of the large amount of material that is available through many websites, the ability to rank interesting articles, postings, comment threads or other content is useful because users can more easily find content that other users have marked as being interesting. In addition, content that has been voted as being interesting can be promoted by a media supplier or website provider.

Despite current abilities for users to submit votes about the user's interest level in content or a comment thread, there are still significant challenges in making relevant content surface for the end users or content consumers. The need for a variety of ways to identify and display interesting provider content and user generated content continues to exist for content providers.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various embodiments are described for ranking content using user feedback. One method can include presenting a content entry to a plurality of users to enable viewing of the content entry. Positive and negative ratings can be captured about the content entry from the plurality of users. A relative deviation value can be calculated using the positive ratings and negative ratings for the content entry to form a raw rating score using a processor. Another operation can be scaling the raw rating score via a power function to form a controversial rating score using a processor. The content entry may then be displayed in a ranked order with other content entries based on the controversial rating score.

An example system is described for ranking content using user feedback. The system can include a presentation module to present content entries to a plurality of users for viewing. A rating module can capture positive and negative ratings for the content entries from the plurality of users. A statistical module can be used to compute a relative deviation value using the positive ratings and negative ratings for content entries to form raw rating scores. Furthermore, a scaling module can apply a power function to the raw rating score to form controversial rating scores. In addition, a display module can display the content entries in a ranked order based on the controversial rating scores.

An example method is also described for ranking content using user feedback to identify a highest rated or a lowest rated score for content entries. The method can include the operation of presenting content entries to a plurality of users to enable viewing of the content entries. Positive and negative ratings can be captured about the content entries from the plurality of users. An inverted relative deviation value can be computed for the positive ratings and negative ratings to form a raw rating score. Another operation can include applying a sign value obtained by comparing the positive ratings and negative ratings to the raw rating score to form a rating score. The content entries can be displayed in a ranked order based on the rating score.

### BRIEF DESCRIPTION OF THE DRAWINGS

FIG. 1 is a flowchart illustrating an example of a method for ranking content using user feedback.

FIG. 2 is an example chart illustrating that when P is close to N, a content entry or topic can be considered controversial content.

FIG. 3 is a chart illustrating an example of a normal distribution to model a distribution of votes on a content entry or topic.

FIG. 4 is a block diagram illustrating an example of a system for ranking content using user feedback.

FIG. 5 is flowchart illustrating an example of a method for ranking content using user feedback to compute a highest rated or a lowest rated score.

### DETAILED DESCRIPTION

Reference will now be made to the example embodiments illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

This technology can provide adaptive content promotion based on user feedback. The content may be user generated content (UGC) or content provided by a media company through the internet or another networked electronic medium. Methods can be provided for promoting or surfacing professionally generated content and/or user generated comments (UGC) based on user feedback data. These methods can include promoting the highest ranked, lowest ranked and most controversial content entries. Standard deviation computations can play a role in this technology for promoting content entries using user feedback.

The technology can allow for adaptive content promotion based on user feedback, and a rating scenario can be used that computes scores for content entries. Content entries can be professionally generated or user generated. Examples of a content entry may include a news article, a feature article, video clip, an image, a forum posting, or an editorial article that end user's desire to view or read. Another example of content entries can include user generated comment (UGC) threads. The ratings can provide user-friendly models to catch the user feedback, such as the number of views, number of positive/negative votes, and number of shared content entries.

The described technology can analyze and summarize the user feedback data to generate rankings for popularity, such as highest ranked, lowest ranked, and most controversial. These rankings can be measured based on a relative standard deviation between the positive and negative votes, and the rankings may also be based on the magnitude of votes. The user supplied ranking data can be combined with the corresponding content, and highly ranked content entries can be widely displayed to other information consumers to attract more users, which in turn can generate more user feedback.

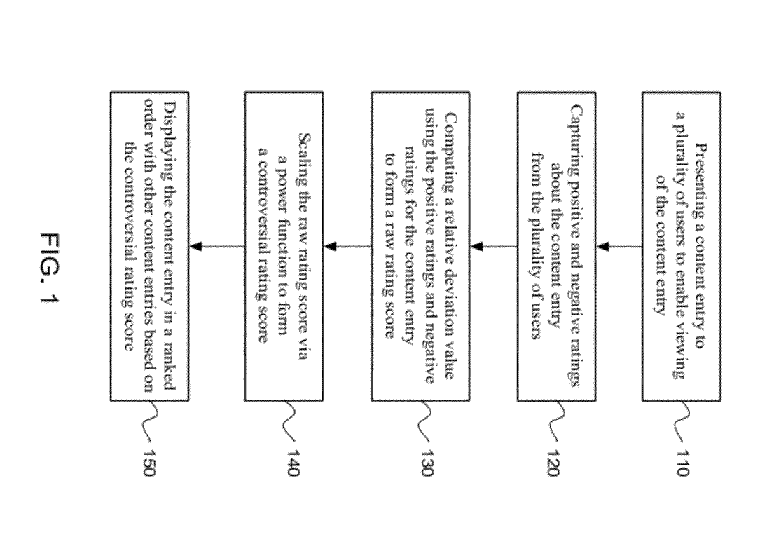

FIG. 1 illustrates a method for ranking content using user feedback. The method can include the operation of presenting a content entry to a plurality of users to enable viewing of the content entry, as in block 110. As discussed previously, the content entry can be an article, comment, or media element that is displayed to an end user of a website or another networked presentation user interface. Positive and negative ratings can be captured about the content entry from the plurality of users, as in block 120. In other words, the users can vote about whether the content entry is of positive interest or negative interest to the user. The vote can also represent whether the users like or do not like the content entry.

A relative deviation value can be computed with the positive ratings and negative ratings for the content entry to form a raw rating score, as in block 130. This relative deviation value represents a relative magnitude of the positive and negative ratings for a content entry from the mean, as compared to other content entry ratings within the standard distribution. The relative deviation value can be computed using a using a processor and values stored in a database device, non-volatile computer memory, or volatile computer memory. The relative deviation value for the positive ratings and the negative ratings can be computed using:

$$\frac{\sqrt{PN}}{P + N}$$

where P is the number of positive ratings for the content entry and N is the number of negative ratings for the content entry.

In order to understand the basis for using the computation described above for finding the relative deviation value, an explanation of the computations for identifying controversial content entries can be discussed.

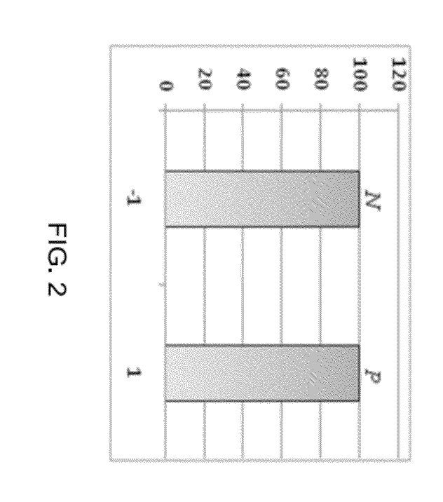

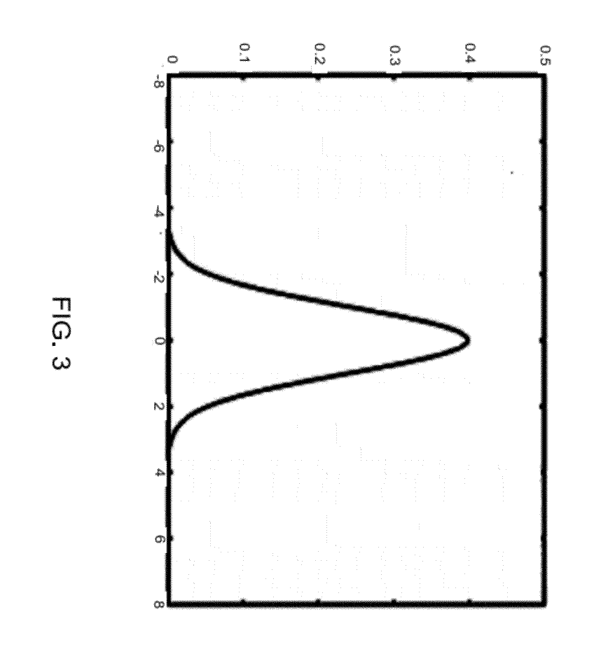

Suppose a content entry or topic T is provided and P is a number of people who think topic T is good, and N is a number of people who think topic T is bad. The value “1” can represent a positive vote and “−1” can represent a negative vote. FIG. 2 illustrates that when P is close to N, then topic T can be considered controversial content. That is, when (−1)×P+(1)×N→0 and both P and N are large, T can be considered controversial. Using standard deviation for a normal distribution with a mean value of zero can model a distribution of votes on a plurality of content entries or topics, as shown in FIG. 3.

Let X be a random variable with mean value 0, and the value for X is either 1 or −1, so:

E[X]=0 (Equation 1)

The standard deviation of X is the quantity

$$σ = \sqrt{\frac{\sum {X}^{2} - \frac{{( \sum X )}^{2}}{P + N}}{( P + N )}} \qquad ( Equation 2 )$$

Because the mean value is 0 and the two relative values are either 1 or −1, then

ΣX²=N(−1−0)²+P(1−0)²=P+N and ΣX=(−1)N+(+1)P=P−N (Eq. 3)

This results in:

$$σ = \sqrt{\frac{( P + N ) - \frac{{( P - N )}^{2}}{P + N}}{( P + N )}} = \frac{2 \sqrt{PN}}{P + N} \qquad ( Equation 4 )$$

Equation 4 is one example formula to get the relative strength of normalized positive and negative ratings. Sample size can also be taken into account, in order to make the computation more precise. The standard error of the sample mean is given by the Equation 5:

σ/\sqrt{P+N} (Equation 5)

Equation 5 can be used to show that as N becomes very large, the error will be small and knowing the standard error can increase the confidence in Equation 4.

Referring again to FIG. 1, a further operation can be scaling the raw rating score via a power function to generate a controversial rating score using a processor, as in block 140. The scaling of the rating score can be a power function that is a logarithmic weighting function or a power weighting function. The scaling function provides an adjusted range for the relative deviation value to compensate for feedback cases where a large number of negative votes N is tied with a small number of positive votes P or a large number of positive votes P is tied with a small number of negative votes N. For example, a large number of votes may be 50,000 positive votes as compared to 100 negative votes and such scaling large differentials can avoid skewing a final controversial rating score. While the scaling function has been described as scaling a raw rating score derived from the relative deviation value, the scaling can be applied directly to the relative deviation value without an intermediate storage location or variable, if desired.

In order to choose an operand for the power function, a minimum value from the positive rating counts and the negative rating counts can be selected as an operand. In addition, the value applied in the power function can be a fractional power. For example, the power applied can be greater than zero and less than ½.

Several options for the scaling or size weighting can be provided as follows:

a. Logarithmic Weight: log_{β} Min(P,N), where β=2 or β=10 (Equation 6)

b. Power Weight: Min(P,N)^{α}, where 0<α<½ (Equation 7)

While the logarithmic weight shows the example bases of 2 and 10, other bases may be used. Furthermore, powers other than the example fractions can be used. Therefore, the method to find the controversial score of content entry or a user generated entry may be either:

$$\begin{matrix}{log}_{β} Min ( P , N ) \times \frac{\sqrt{PN}}{P + N} \\ or & ( Equation 8 ) \\ {Min ( P , N )}^{α} \times \frac{\sqrt{PN}}{P + N} & ( Equation 9 )\end{matrix}$$

The scored content entry can be displayed in a ranked order with other content entries based on the controversial rating score, as in block 150. For example, if a news article or video clip is being ranked, then the most controversial news articles or video clips can be ranked the highest and displayed at the top of a listing presented to an end user. In the example of a user generated content system, the most controversial user content or comments can be shown at the top of a list and the least controversial user content or comments can be shown at the bottom of the list.

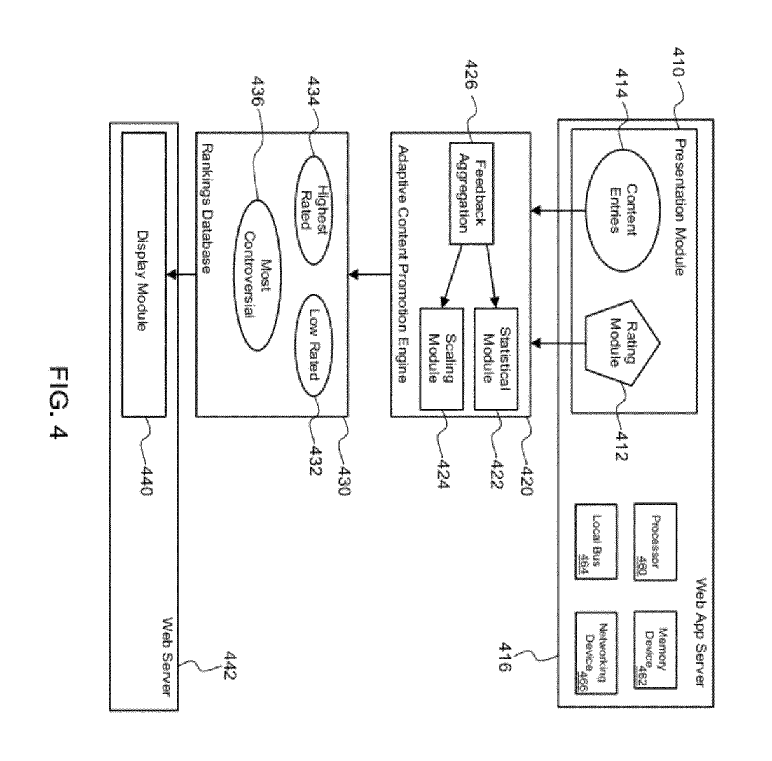

An example system for ranking content using user feedback is illustrated in FIG. 4. The system can include a presentation module 410 to present content entries 414 to a plurality of users for viewing. A rating module 412 can capture positive and negative ratings for the content entries from the plurality of users. The presentation module can provide a user interface to an end user through a web browser or a networked client interface for voting.

A web application server 416 may be located on a server device, a blade server, a workstation, or another computing node. The web application server can include a hardware processor device 460, a hardware memory device 462, a local communication bus 464 to enable communication between hardware devices and components, and a networking device 466 for communication across a network with other computing nodes, processes on other the computing nodes, or other computing devices.

The user feedback can be collected in an aggregation module 426. This allows the user ratings about content entries to be collected for further processing. The user feedback can include positive votes, negative votes, page visits, time spent at certain content, or other user feedback about a content entry.

A statistical module 422 can compute a relative deviation value using the positive ratings and negative ratings for content entries to form raw rating scores. The statistical module can compute a relative deviation value for the positive ratings and the negative ratings using:

$$\frac{\sqrt{PN}}{P + N}$$

where P is the number of positive ratings for the content entry and N is the number of negative ratings for the content entry.

In addition, a scaling module 424 can apply a power function to the raw rating score to form controversial rating scores. The scaling module can select a minimum value from between the positive rating counts and the negative rating counts as an operand for the power function. The power function may be a logarithmic weight calculation or a power weighting calculation. For example, the power function can use a fractional power greater than zero and less than ½.

The statistical module and the scaling module can be located on an adaptive content promotion engine 420. The adaptive content promotion engine may be a server that includes similar hardware components as the web application server. Alternatively, the adaptive content promotion engine can be located on another type of networkable computing device.

A rankings database 430 can also be provided for storing the rankings for content entries or topics. The database can be separated into storage modules or separate databases for storing scores related to each content entry with feedback, including a highest rating scoring 434, lowest rated scoring 432 or the most controversial scoring 436 database. The rankings database may be located or executed on a database server or database hardware device.

A display module 440 can display the content entries in a ranked order based on the controversial rating scores, highest rating scores, or lowest rating scores. The display module may be located on a web server 442, networked server, or other networked computing device that is accessed by end users. As a result, the rankings of the content entries can be displayed using web pages or other networkable user interfaces presented to an end user.

An example application of this technology can be in the area of user generated content (UGC). Initially, positive and negative ratings or voting options are provided to end users or website visitors. Each click or vote for a positive or negative rating can be recorded for the content entries or topics and the accumulated ratings data can saved to a database. Then the user generated comments (UGC) can be sorted using one of three different rating methods. The methods include the: highest rated score, lowest rated score, and most controversial score. The three calculations can combine both the number of positive and negative ratings to sort user generated comments (UGC) in ways that make sense to humans.

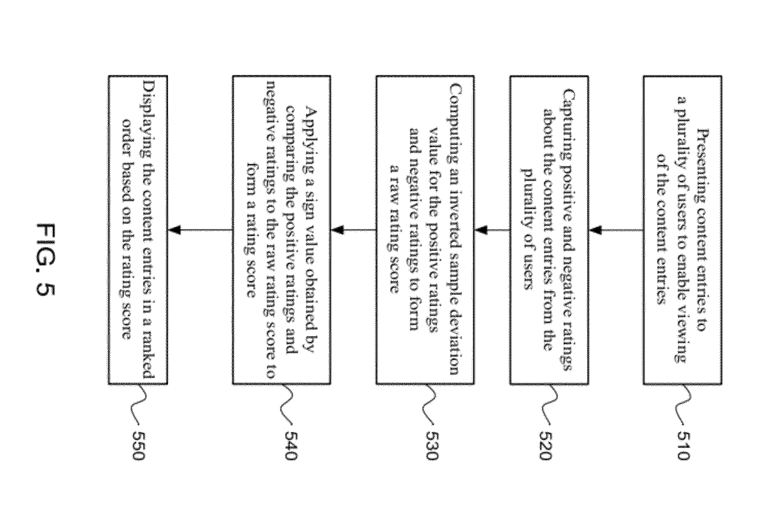

An example method for computing a highest rated score or a lowest rated score can now be discussed. FIG. 5 illustrates an additional method for ranking content using user feedback. The method can include the operation of presenting content entries to a plurality of users to enable viewing of the content entries, as in block 510. Positive and negative ratings about the content entries can be captured from the plurality of users, as in block 520.

An inverted relative deviation value can be computed for the positive ratings and negative ratings to form a raw rating score for a content entry, as in block 530. A sign value can then be obtained by comparing the positive ratings and negative ratings to the raw rating score to form a rating score, as in block 530. The rating score can represent a highest rated or a lowest rated score.

Additional details for the method for calculating the highest rated or lowest rated content entries or topics will now be discussed. For the topic T, if P number of people think topic T is good, and N number of people think topic T is bad, when P is much greater than N, topic T is a high rated topic. That is, when P>>N, T is high rated. While if N>>P, then T is a low rated topic. The less controversial a topic is, the more the topic is high/low rated. Therefore, an inverted relative value or inverted relative strength can be used to measure how “high rated” or “low rated” of a content entry or a topic as follows:

$$\begin{matrix}σ = sign ( P - N ) \times \frac{P + N}{\sqrt{PN}} & ( Equation 10 ) \\ σ = sign ( N - P ) \times \frac{P + N}{\sqrt{PN}} & ( Equation 11 )\end{matrix}$$

Equations 10 and 11 can be used to measure how high or low rated a topic is respectively. An inverted relative deviation value can be computed for the positive ratings and the negative ratings using:

$$\frac{P + N}{\sqrt{PN}}$$

where P is the number of positive ratings for the content entry and N is the number of negative ratings for the content entry. In other words, the inverted sample deviation can be used because the inverted sample deviation shows how far away from the inverted mean a highest rated or lowest rated content entry is. This type of a highest and lowest rating system is useful because content entries can be more accurately rated and distributed than with a simple linear scoring system.

Equation 10 can be used to compute a sign value to determine how high a content entry is rated by subtracting a negative rating count from a positive rating count and applying the resulting sign to the rating score. On the other hand, Equation 11 can be used to obtain a sign value to determine how low a content entry is rated by subtracting a positive rating count from a negative rating count and applying the resulting sign to the rating score. Thus, the magnitude of relative value is computed using

$$\frac{P + N}{\sqrt{PN}}$$

while the sign is determined by whether the highest or lowest rating is being sought and subtracting the appropriate positive and negative vote values.

The content entries can be displayed in a ranked order based on the rating score, as in block 550. The content entries can be displayed in a numbered list or another user interface control in a web browser or a networked computing application.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for ranking content using user feedback, comprising:
presenting a content entry to a plurality of users to enable viewing of the content entry;
capturing positive and negative ratings about the content entry from the plurality of users;
computing a relative deviation value using the positive ratings and negative ratings for the content entry using a processor;
scaling the relative deviation value via a power function to form a controversial rating score using a processor; and
displaying the content entry in a ranked order with other content entries based on the controversial rating score.

2. The method as in claim 1, further comprising selecting a minimum value from positive rating counts and negative rating counts as an operand for the power function.

3. The method as in claim 1, further comprising scaling the rating score using a logarithmic weight function.

4. The method as in claim 1, further comprising scaling the rating score using a power weighting function.

5. The method as in claim 4, further comprising applying the power weighting function where a power applied is a fractional power.

6. The method as in claim 4, further comprising applying the power weighting function where a power applied is greater than zero and less than ½

7. The method as in claim 1, further comprising computing a relative deviation value for the positive ratings and the negative ratings using:
$$\frac{\sqrt{PN}}{P + N}$$
where P is a number of positive ratings for the content entry and N is a number of negative ratings for the content entry.

8. A system for ranking content using user feedback, the system comprising:
a presentation module to present content entries to a plurality of users for viewing;
a rating module to capture positive and negative ratings for the content entries from the plurality of users;
a statistical module to compute a relative deviation value using the positive ratings and negative ratings for content entries to form raw rating scores;
a scaling module to apply a power function to the raw rating scores to form controversial rating scores; and
a display module to display the content entries in a ranked order based on the controversial rating scores.

9. The system as in claim 8, wherein the scaling module selects a minimum value from between the positive rating counts and the negative rating counts as an operand for the power function.

10. The system as in claim 8, wherein the scaling module scales the raw rating score using a power function that is a logarithmic weight function.

11. The system as in claim 8, wherein the scaling module scales the raw rating score using a power weighting function.

12. The system as in claim 8, wherein the scaling module applies the power function using a fractional power.

13. The system as in claim 8, further comprising applying the power function using a power greater than zero and less than ½.

14. The method as in claim 8, wherein the statistical module computes a relative deviation value for the positive ratings and the negative ratings using:
$$\frac{\sqrt{PN}}{P + N}$$
where P is a number of positive ratings for the content entry and N is a number of negative ratings for the content entry.

15. The system of claim 8, wherein a web server is used to execute the rating module and to capture positive and negative ratings about the content entries.

16. A method for ranking content using user feedback, comprising:
presenting content entries to a plurality of users to enable viewing of the content entries;
capturing positive and negative ratings about the content entries from the plurality of users;
computing an inverted relative deviation value for the positive ratings and negative ratings to form a raw rating score;
applying a sign value obtained by comparing the positive ratings and negative ratings to the raw rating score to form a rating score; and
displaying the content entries in a ranked order based on the rating score.

17. The method as in claim 16, further comprising computing the rating score that is a highest rated or a lowest rated score.

18. The method as in claim 17, wherein applying a sign value further comprises obtaining a sign value to determine how high a content entry is rated by subtracting a negative rating count from a positive rating count and applying the resulting sign to the raw rating score.

19. The method as in claim 17, wherein applying a sign value further comprises obtaining a sign value to determine how low a content entry is rated by subtracting a positive rating count from a negative rating count and applying a resulting sign to the raw rating score.

20. The method as in claim 16, further comprising computing an inverted relative deviation value for the positive ratings and the negative ratings using:
$$\frac{P + N}{\sqrt{PN}}$$
where P is a number of positive ratings for the content entry and N is a number of negative ratings for the content entry.
